(19) United States
(12) Patent Application Publication
(10) Pub. No.: US 2019/0150428 A1
(43) Pub. Date: May 23, 2019

(54) Packaged Mosquito Attractant Composition, Mosquito Attractant Cartridge, and Insect Trapping Device

(71) Applicant: The Procter & Gamble Company, Cincinnati, OH (US)

(72) Inventors: Hirotaka Uchiyama, Cincinnati, OH (US); Eugene Steven Sadlowski, Cincinnati, OH (US); Benjamin Patrick Hale, West Chester, OH (US)

(21) Appl. No.: 16/253,354

(22) Filed: Jan. 22, 2019

Related U.S. Application Data
(63) Continuation of application No. PCT/US2017/044276, filed on Jul. 28, 2017.
(60) Provisional application No. 62/368,867, filed on Jul. 29, 2016.

(51) Int. Cl. A01N 25/00; A01N 25/10; A01M 1/02; A01M 1/10

(52) U.S. Cl. CPC A01N 25/002; A01N 25/10; A01M 2200/012; A01M 1/106; A01M 1/02

(57) ABSTRACT

Mosquito attractant compositions including a gellan gum, a humectant, and water are disclosed. The mosquito attractant compositions attract mosquitoes when exposed to air for a period of at least 7 days. Methods of using and forming the mosquito attractant compositions as well as insect attractant devices are also disclosed.

### TECHNICAL FIELD

The present disclosure is generally related to mosquito attractant compositions and more particularly, to mosquito attractant compositions, insect attractant cartridges, and insect attractant inserts that can be used to attract mosquitoes to an insect trapping device over an extended period of time.

### BACKGROUND

Certain insects, such as mosquitoes, can be both a nuisance and a health risk to humans.

For example, mosquito bites can cause painful irritation at bite locations and can infect humans with a variety of diseases including yellow fever, dengue fever, malaria, chikungunya, elephantiasis, west nile, zika, tularemia, and other debilitating diseases which can be difficult to treat. Some have estimated that mosquitoes may be responsible for more than 750,000 deaths per year. Bill Gates, The Deadliest Animal in the World, Gatesnotes (2014). The World Health Organization (“WHO”) has estimated that Yellow Fever infects 84,000 to 170,000 people per year and results in 29,000 to 60,000 deaths. WHO FactSheet (2016). The WHO has also stated that there are an estimated 390 million dengue infections per year, with an estimated 500,000 requiring hospitalization. WHO FactSheet (2016). More recently, the WHO has labeled Zika as a public health emergency due to Zika's causal relationship with microcephaly and other neurological disorders. The Aedes aegypti mosquito is a known vector for yellow fever, dengue fever, and zika. Other mosquito species believed to be carriers of human disease include Aedes albopictus, Aedes canadensis, Anopheles gambiae, Anopheles funestus, Culex annulirostris, Culex annulus and Culex pipiens.

Insect trapping devices are known. Some examples are described in U.S. Pat. Nos. 4,907,366; 6,920,716; 7,074,830; U.S. Patent App. Publication No. 2006/0188540; U.S. Patent App. Publication No. 2010/0287816; U.S. Patent App. Publication No. 2012/291337; U.S. Patent App. Publication No. 2014/0311016; KR Publication No. 2012/0132132; PCT Patent App. Publication No. WO 2015/081033; and PCT Patent App. Publication No. WO 2015/164849. Although insect trapping devices are generally known in the art, there are opportunities to improve insect trapping devices by improving chemical attraction mechanisms which draw mosquitoes, such as, for example, fruit flies or the disease spreading Aedes aegypti mosquito, to the device. For instance, it would be advantageous to provide mosquito attractant compositions that are safe and effective for use in spaces occupied by pets, children and/or adults, such as a room in a building or residence. It would be further advantageous to provide mosquito attractant compositions that are effective for at least 7 days, at least 14 days, or more, before needing replacement to improve the convenience of an insect trapping device for the user. Further, it would be advantageous to provide mosquito attractant compositions that are stable at elevated temperatures so that they are safe for use in an electrical insect trapping device. It would still further be advantageous to provide water containing mosquito attractant compositions that are formulated at either a low or a high pH in order to retard the growth of mold during shipment, storage and/or use. While numerous opportunities for improvement are described above, it will be appreciated that the disclosure hereafter is not limited to mosquito attractant compositions that provide any or all such improvements.

### SUMMARY

According to one example, a method of using a mosquito attractant composition includes exposing the mosquito attractant composition to air for a period of at least 7 days. The mosquito attractant composition includes from about 0.5% to about 5%, of a gellan gum, from about 0.5% to about 50% of a humectant, and from about 45% to about 95% water. The mosquito attractant composition attracts mosquitoes or fruit flies when exposed to the air.

### BRIEF DESCRIPTION OF THE DRAWINGS

The above-mentioned and other features and advantages of the present disclosure, and the manner of attaining them, will become more apparent and the disclosure itself will be better understood by reference to the following description of non-limiting embodiments of the disclosure taken in conjunction with the accompanying drawings, wherein:

FIG. 1 depicts an isometric view of an exemplary insect trapping device according to one example.

FIG. 2 depicts an exploded isometric view of the insect trapping device of FIG. 1, showing a shell that receives an insert having a reservoir storing a mosquito attractant composition.

FIG. 3 depicts an exemplary disposable insert according to one example having a mosquito attractant composition disposed therein.

FIG. 4 depicts an exploded view of the disposable insert storing the mosquito attractant composition depicted in FIG. 3.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the disclosure will be apparent from the following detailed description, and from the claims.

### DETAILED DESCRIPTION

As used herein, “gel” means any composition comprising a liquid and having a three-dimensional, cross-linked, network.

As used herein, “gelling agent” means any material, or combination of materials, that facilitate the formation of the three-dimensional, cross-linked, network of a gel.

As used herein, “high acyl” means a gellan gum that has two acyl substituents: acetate and glycerate. Both substituents are located on the same glucose unit, and on average, there is one glycerate per repeat and one acetate per every two repeats.

As used herein, “low acyl” refers to a gellan gum having no acyl groups.

As used herein, “mosquito” means any species of mosquito that is human host seeking. In certain instances, mosquito refers to any species of the genus Aedes, Culex or Anopheles. In certain instances, mosquito refers to any species of the subgenus Stegomyia of the genus Aedes. In some instances, mosquito refers to the species Aedes aegypti (Ae. aegypti).

As used herein, “package” refers to any article of manufacture that functions as a primary package during storage, shipment or display at the point of sale to an end user that encloses a mosquito attractant composition, or an insect trap portion (e.g., a cartridge or insert) comprising a mosquito attractant composition.

The present disclosure provides for mosquito attractant compositions, and insect trapping devices, including components such as inserts and cartridges, that contain a mosquito attractant composition. Methods of making and using the mosquito attractant compositions are further disclosed. The mosquito attractant compositions comprise a gellan gum, a humectant, and water.

Advantageously, it is believed that a mosquito attractant composition in the form of a gel comprising a gellan gum and humectant can (a) be formulated at either a low pH or high pH to retard mold growth in the package or later during use, and/or (b) be provided in stable form that resists liquid flow and/or syneresis so that the mosquito attractant composition can be safely used in combination with an electrically powered insect trapping device. Further, it is presently believed that mosquito attractant compositions comprising a gellan gum, water and a humectant can attract at least some types of mosquitoes over an extended period time, with or without the addition of further chemical attractants. In certain embodiments, the mosquito attractant composition is homogenous with the various ingredients dispersed throughout a single composition.

Various non-limiting examples of the present disclosure will now be described to provide an overall understanding of the principles of the function, design, and use of mosquito attractant compositions, and insect trapping devices (and components thereof) described herein. Those of ordinary skill in the art will understand that the examples described herein are non-limiting and that the scope of the various non-limiting examples of the present disclosure are defined solely by the claims. The features illustrated or described in connection with one non-limiting example can be combined with the features of other non-limiting examples. Such modifications and variations are intended to be included within the scope of the present disclosure.

### I. GELLAN GELLING AGENTS

The mosquito attractant compositions described herein are gelled through inclusion of at least a gellan gum. Gellan gum is a water-soluble anionic polysaccharide, typically produced by fermentation using the bacterium Spingomonas elodea. Gellan gum is available in either a low acyl or a high acyl form. Further, gellan gum is also available as a food grade material. Some examples of suitable gellan gums are available from CP Kelco (USA) under the brand name KELCOGEL®. Gelling of a mosquito attractant composition may confer a number of benefits over non-gelled mosquito attractant compositions. For example, gelled compositions may exhibit a longer effective life, can resist spilling, and can provide increased consumer flexibility by simplifying handling, disposal, and use. Additionally, gelling of the mosquito attractant compositions described herein, in combination with an appropriate concentration of a humectant, can allow for controlled evaporation of water vapor when compared to non-gelled compositions. In the form of a gel, the mosquito attractant compositions described herein can effectively operate for an extended duration of about 7 days, or more. In certain examples, the mosquito attractant compositions described herein can effectively operate for about 7 days, 14 days, or more.

While there are advantages to a gelled mosquito attractant composition, there are also challenges with formulating such compositions. First, it is desirable to include a sufficient amount of water in the composition to attract at least some mosquitoes over a sufficient period of time. However, formulating compositions with high concentrations of water, a gelling agent and a humectant may lead to mold formation over time, which is undesirable in a consumer product. Formulating a mosquito attractant composition at either a low pH or high pH can retard mold formation, however, this can introduce added challenges such as the ability to form a stable composition that resists flowing and syneresis at elevated temperatures so that the composition is safe for use in connection with an electrical insect trapping device. Also, in certain embodiments, it is desirable for the composition to be manufactured and deposited in a reservoir or cartridge in a flowable form and yet form a gel within an acceptable period of time (e.g., the time to form a gel is not excessive). While some other natural gelling agents may be used to form mosquito attractant compositions (e.g., agar and gelatin), it is believed that gellan gum is more preferred for addressing one or more of the foregoing challenges. For example, agar compositions formulated at low pHs (e.g., pH of 2.5) are less stable than gellan gum compositions formulated at the same pH (see, e.g., Table 5). Further, it is believed that gellan gum compositions comprising glycerol are directionally more attractive to mosquitoes when formulated at lower pHs, such as for example between about 2 and about 3 (see, e.g., Examples 1 and 3), than when formulated at higher pHs (see, e.g., Examples 7, 8 and 9).

Gellan gum is a cold set gelling agent. Cold set gelling agents are gelling agents that form a gel after heating of a liquid composition containing the gelling agent and subsequent cooling of the liquid composition. For example, mosquito attractant compositions described herein can be gelled by heating a liquid attractant composition to a temperature of about 60° C. to about 80° C. and then allowing the liquid attractant composition to cool to a temperature of about 60° C. or less.

Gellan gum also exhibits a number of other advantageous properties. For example, gellan gum provides for manufacturing flexibility by exhibiting a large temperature spread between the melting temperature and the set temperature. This temperature spread provides for a relatively large amount of work time to, for example, form a heated liquid attractant mixture and then store and deliver the heated liquid mixture before formation of the gel. This work time can facilitate dispensing of the liquid mosquito attractant composition into a package, insert, or cartridge and then cooling of the liquid composition to form a gel.

In certain examples, a liquid attractant composition can be gelled to form a mosquito attractant composition through inclusion of about 0.5% to about 5%, by weight, gellan gum. For example, in certain examples, a mosquito attractant composition can include about 1% to about 3%, by weight, gellan gum or can include about 1% to about 2%, by weight, gellan gum. Insufficient quantities of gellan gum can form gels having insufficient strength, or resistance to flow, while excess quantities of gellan gum (e.g., greater than 5 wt %) can form viscous gels of unworkable strength or which are difficult to process.

Generally, suitable gellan gums can be selected from any known gellan gums including, for example, high acyl gellan gums and low acyl gellan gums. In certain examples, a blend of both high acyl gellan gum and low acyl gellan gum can be included in a mosquito attractant composition. In other certain examples, only one gellan gum, such as a low acyl gellan cum, can be selected. Suitable gellan gums can also be of any known grade of gellan gum including low-purity commercial gellan gum grades and high-purity food grade gellan gums. It can useful in certain examples to select a food grade gellan gum to minimize any health consequences if the mosquito attractant composition is swallowed by a human or animal. Selection of a food grade gellan gum in combination with a food grade humectant can allow certain mosquito attractant compositions described herein to advantageously be entirely formed from food grade components.

In certain examples, supplemental gelling agents can also be included in a mosquito attractant composition. For example, one or more of agar, gelatin, carrageenan, starch, alginate, xanthan, gum Arabic, guar, locust bean gum, tara, konjac, tragacanth, cellulose, modified cellulose, and clay can supplement the gellan gum used to gel a mosquito attractant composition. In certain such examples, a supplemental gelling agent may be included in relatively smaller quantities than gellan gum.

### II. HUMECTANTS

One or more humectants may be included in a mosquito attractant composition in certain examples to lower the evaporation rate of water and improve the effective lifespan of the mosquito attractant composition. The lifespan of a mosquito attractant composition may depend, in part, on the amount of moisture present in the gel with complete evaporation of the water diminishing, or preventing, the further attraction of mosquitoes (assuming no other volatile mosquito attractants are present in the composition). Non-limiting examples of humectants suitable for the mosquito attractant compositions described herein can include glycerol, sorbitol, xylitol, ethylene glycol, diethylene glycol, polyethylene glycol, propanediol, and mixtures thereof. In certain examples, it can be preferable to use a natural humectant such as glycerol to improve the safety and effectiveness of a mosquito attractant composition. Examples 1, 2 and 3 illustrate that although various humectants may be utilized in a mosquito attractant composition that attracts mosquitoes, glycerol appears to have directionally better attraction for mosquitoes at 14 days compared to sorbitol.

A suitable humectant can be included at about 0.5% to about 50%, by weight, or about 1% to about 40%, by weight, or about 5% to about 30%, by weight, or about 5% to about 15%, by weight of the mosquito attractant composition. At concentrations approaching 50%, by weight, of a humectant, it is believed that attraction of mosquitoes by the composition diminishes compared to lower concentrations of a humectant (see, e.g., Example 6), possibly due too high retention of water by the mosquito attractant composition. Generally, suitable levels of humectants will produce mosquito attractant compositions which confer a longer lifespan for the mosquito attractant composition without lowering the evaporation rate of water to a level below the rate at which mosquitoes are attracted.

### III. PH AND PH ADJUSTING AGENTS

In certain examples, the pH of a mosquito attractant composition can be adjusted through the addition of a pH adjusting agent, such as an acid or a base. The use of a pH probe, or an appropriate titration method, can allow for precise measurement, and adjustment, of the pH value as known in the art during formation of the mosquito attractant composition. Generally, the pH of a mosquito attractant composition can be lowered through the addition of an acid such as hydrochloric acid (“HCl”) or increased through the addition of a base such as sodium hydroxide (“NaOH”) or ammonium hydroxide. The pH of the insect attractant composition can also be influenced by any optional components included in the composition. The pH of a gel can be determined by diluting the gel with excess distilled water to form a 10% aqueous solution. In certain embodiments, the pH of the mosquito attractant composition may be adjusted during formulation to achieve a target pH from about 2 to about 4 or from about 2 to about 3. In certain embodiments, the pH of the mosquito attractant composition may be adjusted during formulation to achieve a pH from about 8 to about 12 or from about 10 to about 12. The pH of the mosquito attractant composition may be measured using the pH Test Method described in Section X.

### IV. WATER

The mosquito attractant compositions comprise water, which advantageously is released from the composition over time during use and may attract at least certain mosquitoes. The mosquito attractant composition comprises water in an amount, by weight, from about 45% to 99%, or from about 70% to about 95% or from about 75% to about 85%, which are believed to be sufficient amounts to evaporate and attract at least certain mosquitoes over at least 7 days, at least 14 days, or more.

### V. ADDITIONAL COMPONENTS

As can be appreciated, a variety of additional components can be included in certain mosquito attractant compositions described herein. For example, additional mosquito attractant additives can optionally be included in certain examples.

Generally, any known mosquito attractant additive which is compatible with the mosquito attractant compositions described herein can optionally be included in the compositions. For example, lactic acid may be included in an amount, by weight of the mosquito attractant composition, from about 0.5% to about 30%, or about 1% to about 25%, or about 1.5% to about 20%. These ranges are exclusive of non-acid constituents, such as water or other solvents, which might be included with the raw material used to make the mosquito attractant composition.

As can be appreciated, a mosquito attractant composition as described herein can optionally include other additional components to further improve, or tailor, the properties of the composition. For example, in certain examples, a preservative can optionally be included in a mosquito attractant composition to prevent degradation of the composition. In certain examples, the preservative can also, or alternatively, be a biocide which prevents the growth of bacteria and fungi. Suitable preservatives can include one or more of 1,2-benzisothiazolin-3-one (“BIT”), benzoic acid, benzoate salts, hydroxy benzoate salts, nitrate, nitrite salts, propionic acid, propionate salts, sorbic acid, and sorbate salts. Other suitable preservatives are known in the art.

A fragrance can optionally be included in certain examples. As can be appreciated however, in certain examples, a mosquito attractant composition can be odorless when formed from odorless components. For example, a mosquito attractant composition comprising gellan gum, glycerol, and water can be odorless to humans as each of the components in the composition are odorless to humans. Odorless compositions may be preferred for increased consumer acceptance.

In certain examples, the mosquito attractant compositions described herein can also, or alternatively, be substantially free of certain components. For example, the mosquito attractant compositions can be substantially free of oils, essential oils, insecticides, biocides, repellants, and perfumes which may adversely affect the attraction of desired mosquitoes to the composition. Excluded biocides can include bacteria or virus harmful to an insect. In certain examples, the mosquito attractant compositions can be essentially free of oils, essential oils, insecticides, biocides, repellants, and perfumes. In certain examples, the mosquito attractant compositions can be free of oils, essential oils, insecticides, biocides, repellants, and perfumes. In certain embodiments, the mosquito attractant composition may consist essentially of or consist of water, one or more gellan gums, one or more humectants and optionally one or more pH adjusting agents.

### VI. PACKAGING

The mosquito attractant compositions may be packaged prior to use. Any suitable type of package may be utilized. Some non-limiting examples of packages include boxes, cartons, clam-shell containers, bags, pouches and the like. In certain embodiments, a package may be formed from a paper material, a plastic material and combinations thereof.

### VII. METHOD OF MAKING A MOSQUITO ATTRACTANT COMPOSITION COMPRISING GELLAN, WATER AND A HUMECTANT

One non-limiting method of making a mosquito attractant composition is the following:
1. Form a humectant premix in a container by adding and mixing all of the water and humectant needed for a mosquito attractant composition together. Optionally, add a pH adjusting agent, such as sodium hydroxide or hydrochloric acid, as needed, to obtain the desired pH.
2. Mix the humectant premix with an impeller mixer for two, or more, minutes. The humectant premix can be stored for no more than 1 week.
3. Slowly add the desired quantity of gellan gum to the humectant premix to form a liquid attractant composition. The gellan gum should be added slowly to avoid clumping and fisheye formation. The liquid attractant composition should be mixed with a spatula until dispersed.
4. Incrementally heat the liquid attractant composition in a microwave until a temperature of 70 to 80° C. is reached. The liquid attractant composition should be mixed at intervals.
5. Place a pre-heated (80° C.) high-shear mixer into the heated liquid attractant composition and activate the high-shear mixer at 6,500 RPM. (Setting 1 on a IKA Ultra-Turrax T25 Basic mixer). Mix for at least one minute.
6. Dispense the heated liquid attractant composition and allow the composition to cool. The heated liquid attractant composition can be dispensed with a peristaltic pump or syringe.

In another method, a premix is formed comprising the humectant and gellan gum. This premix is then added to the water and then heated to 80° C. While a pH adjusting agent may be added at any step in the above described process before the gel begins to solidify, in some instances the water is adjusted to the desired target pH of the final mosquito attractant composition using a pH adjusting agent and the humectant/gellan premix is then added to the pH adjusted water.

Preferably, the gellan gum solution is held at 70-80° C. for less than 5 hours to avoid hydrolysis of the gellan gum. Further, it is desirable to minimize or avoid mechanical shearing of the mosquito attractant composition below 60° C. while the gel network is forming.

As can be appreciated, many variations to the above process are possible. For example, the step of adding a pH modifier can occur at a different stage in the process. Laboratory equipment can be substituted for similar machines from other manufacturers.

### VIII. STABILITY AND SYNERESIS

In certain embodiments, it is desirable for the mosquito attractant composition to be stable at elevated temperatures over extended periods of time. Still further, in certain embodiments, it may be desirable for the mosquito attractant composition to be resistant to syneresis at elevated temperatures. For example, the mosquito attractant compositions may be exposed to elevated temperatures during storage, shipping or usage. Compositions that undergo hydrolysis, become flowable or which undergo syneresis (release of liquid water) may impact efficacy or present an unsafe condition when used in combination with an electrical insect trapping device. Stability is evaluated using the Open Container Test Method described in Section X, and resistance to syneresis is evaluated using the Closed Container Test Method described in Section X.

It has found that mosquito attractant compositions comprising a gellan gum have better stability at lower pHs (e.g., about 2 to about 3) over extended time periods (e.g., preferably at least 30 days) than some other natural gelling agents (e.g., agar and gelatin) and can be formulated into compositions that can attract mosquitoes.

### IX. INSECT TRAPPING DEVICES, CARTRIDGES AND INSERTS

The mosquito attractant compositions disclosed herein can beneficially be used in combination with a wide variety of insect trapping devices to attract and remove mosquitoes from a space, such as a room in a residence or building. In certain examples, the mosquito attractant composition is effective enough that the devices preferably do not incorporate a CO₂ generating means or emitter as an additional mosquito attractant. In certain examples, the insect trapping device does not rely on a mechanism, such as electric fan, to induce an airflow over the mosquito attractant composition to enhance evaporation. The insect trapping devices may attract mosquitoes as well as other flying or crawling insects, such as flies, moths and gnats, for example. In this sense, the insect trapping device may be a broad spectrum insect trap. In certain examples, the insect trapping devices can be enhanced by incorporating one or more broad spectrum lights. The mosquito attractant compositions can help attract mosquitoes to an insect trapping device which permanently traps and removes mosquitoes as well as other insects. A wide variety of insect trapping devices are generally known in the art and are suitable for use with the compositions described herein. Some non-limiting examples are disclosed in U.S. Pat. Nos. 6,108,965; 7,191,560; PCT Patent App. No. WO 2014/134,371; PCT Patent App. No. WO 2015/081,033; and PCT Patent App. No. WO 2015/164,849, each of which is incorporated herein by reference.

Insect trapping devices may generally share a number of similar features. For example, insect trapping devices can include one or more attraction mechanisms to attract mosquitoes to the device. Examples of such insect attraction mechanisms can include a mosquito attractant composition such as the compositions disclosed herein as well as heat, light, and/or food. In certain embodiments, the insect trapping device is an electrical device, meaning it utilizes electricity to power one or more elements such as a light or heating element. Once a mosquito is attracted to an insect trapping device, one or more trapping mechanisms can prevent the mosquito from leaving the device. For example, a mosquito may be trapped on an adhesive sheet, enter into a chamber that is difficult to exit, or be killed (for example by electrocution).

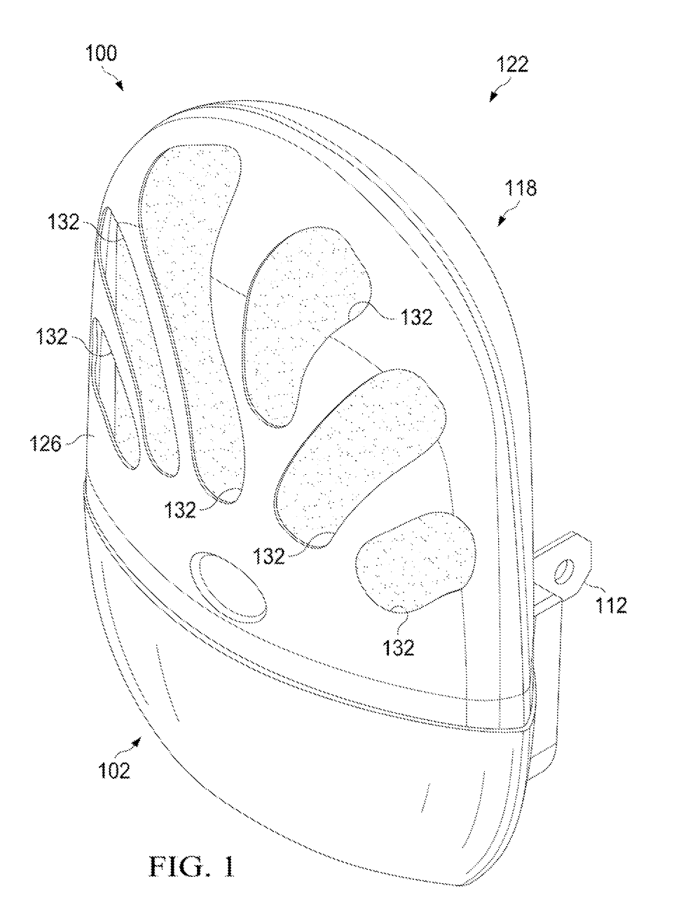

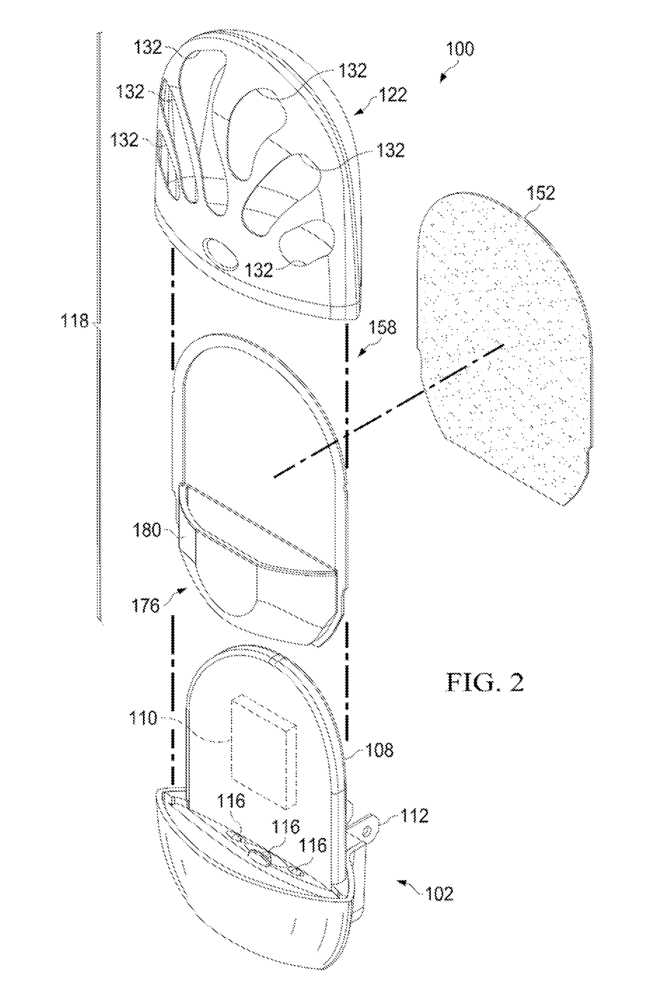

In certain examples, an exemplary insect trapping device comprises a base unit and a disposable insect trapping portion, such as either a disposable cartridge or a disposable insert which may be inserted into a shell as illustrated by, for example, the insect trapping devices depicted in FIGS. 1 and 2 described hereinafter. The disposable cartridge and the disposable insert each further may comprise a mosquito attractant composition. In certain embodiments, the insect trapping portion comprises a housing having one or more openings for receiving a flying or crawling insect and a mosquito attractant composition such as a composition disposed therein. In such examples, mosquitoes can be attracted by the composition and can be trapped within the housing by the adhesive portion. Suitable quantities of a mosquito attractant composition for an insect trapping device can vary from about 1 gram to about 50 grams in certain examples, from about 5 grams to about 40 grams in certain examples, and from about 10 grams to about 30 grams in certain examples. In certain examples, a gelled mosquito attractant composition can be formed by disposing a hot, liquid mosquito attractant composition within an insect trapping device, or a portion thereof such as a cartridge or a housing, and allowing the composition to cool and form a gel. As can be appreciated, certain optional features can be included in various examples to further improve an insect trapping device.

In certain examples, the disposable cartridge and the disposable insert comprise an adhesive portion for trapping mosquitoes, which may be in the form of an adhesive sheet. The adhesive portion may comprise a substrate having an adhesive composition coated thereon. In certain such examples, the adhesive portion can divide the housing into a front enclosure and a rear enclosure. A mosquito attractant composition can be included in one, or both, of such enclosures to attract mosquitoes. The enclosures can have one or more openings to allow mosquitoes to enter. Alternatively, in certain examples, mosquitoes can be mechanically trapped within the housing through a substantially one-way opening.

Additionally, or alternatively, an insect trapping device can include additional features to attract mosquitoes. For example, in certain examples, an insect trapping device can include one or more lights to attract a variety of mosquitoes. In certain such examples, the lights can comprise a plurality of light emitting diodes (“LEDs”) and can emit light at a spectrum attractive to mosquitoes such as a substantially blue light and/or ultraviolet light. In such examples, a suitable power source such as batteries, solar panels, or connections to wired power sources or the like can be included. For example, prongs for an AC power outlet can be included in certain examples. Certain insect trapping devices can also emit heat to attractant mosquitoes. As can be appreciated, heat can be generated through an electric heating element, a chemical reaction or the like.

Some have speculated that carbon dioxide is a long distance attractant for at least certain mosquito species. See, e.g., Carde et al., Olfaction in Vector-Host Interactions, Ecology and Control of Vector Borne Diseases, Vol. 2, pg. 128 (2010) (speculating that “[t]his finding could mean that for Ae. aegypti the ‘long distance’ attractant is carbon dioxide and not human skin odor, and/or that carbon dioxide lowers the threshold for attraction to a human skin odor, acting at some distance from the host”). Since carbon dioxide is thought by at least some to be a long range mosquito attractant, insect trapping devices of the present disclosure can be devoid of a carbon dioxide generating means or emitter so as to reduce the possibility of the insect trapping device drawing mosquitoes into an enclosed space, such as a room, from outside of the building.

Examples of carbon dioxide generating means which are preferably excluded from the devices described herein include the burning or catalytic conversion of a fuel source, chemical reactions between certain components such as a carbonate salt and an acid, the evaporation of dry ice, fermentation, or the use pressurized carbon dioxide cartridges. Additional details of these, and other excluded carbon dioxide means, are described in U.S. Pat. Nos. 7,074,830; 6,209,256; 4,907,366, U.S. Patent App. Publication No 2013/142753; U.S. Patent App. Publication No. 2010/0287816; U.S. Patent App. Publication No. 2004/128902; and U.S. Patent App. Publication No. 2004/025412.

In certain examples, an insect trapping device can be formed of multiple parts. For example, in certain examples, an insect trapping device comprises a plug-in unit that may engage an electrical wall outlet and a disposable insect trapping cartridge. In such examples, a plug-in unit may provide structural stability, lighting, and heating elements while an insect trapping cartridge comprises a mosquito attractant composition and an adhesive portion to capture mosquitoes and other insects. In certain examples, the insect trapping device can emit heat or activate the one or more lighting elements when the insect trapping cartridge is inserted into the plug-in unit. The cartridge comprising the adhesive portion and the mosquito attractant composition may be removed from the plug-in unit and disposed of when the mosquito attractant composition is exhausted and/or when the adhesive portion is filled with insects. The spent cartridge is then replaced by a fresh, new cartridge. A kit including the plug-in unit and the insect trapping cartridge can be sold together with further replaceable insect trapping cartridges sold separately. In certain examples, the insect trapping device can be a single, disposable, item and can be sold without a separate plug-in unit.

Many additional variations are possible. For example, in certain examples, the housing of an insect trapping device or cartridge can be reused by providing a releasable, replaceable insert comprising the mosquito attractant composition and/or an adhesive portion for trapping mosquitoes and insects. When the adhesive portion is full of insects and/or the mosquito attractant composition is effectively exhausted, then the spent insert can be disposed of and a new, fresh insert can be inserted into the cartridge without necessitating disposal of the functional housing. In certain examples, the releasable insert comprises a reservoir containing a mosquito attractant composition described herein. Some non-limiting examples of the previously described inserts, reservoirs, cartridges and insect trapping devices utilizing the same are described in PCT Patent Application Serial No. PCT/US16/41812, entitled INSECT TRAPPING DEVICE AND METHODS THEREOF, and filed on Jul. 11, 2016, the disclosure of which is incorporated herein by reference.

The exact dimensions of the reservoir can be varied depending upon the design on the mosquito attractant composition. For example, in certain examples, the reservoir can include a front wall and a substantially planar rear wall. In certain such examples, the insert can comprise the adhesive portion so that replacement of the insert provides a fresh adhesive portion. In certain such examples, the insert can comprise a frame at least partially surrounding the adhesive portion. The frame may be integrally formed or integrated with the reservoir. For example, in examples including a reservoir having a front wall and rear wall, the front wall and the rear wall can be integrally formed with the frame. The adhesive portion can be transparent or translucent. Other non-limiting examples of reservoirs suitable for use with the mosquito attractant compositions described herein are described in PCT Patent App. Publication No. WO 2015/081033 and PCT Patent App. Publication No. WO 2015/164849, the disclosures of which are incorporated herein by reference.

One non-limiting example of an exemplary insect trapping device is depicted in FIG. 1. The insect trapping device illustrated in FIG. 1 includes several trap mechanisms and attraction mechanisms as shown in better detail in the exploded view depicted in FIG. 2. Specifically, the insect trapping device 100 comprises a cartridge 118 and a plug-in unit 102. The cartridge 118 comprises a shell 122 into which an insert 158 may be inserted. The cartridge 118 may removably engage the plug-in 102. The insert 158 includes an adhesive portion 152 which immobilizes and traps insects that enter the insect trapping device 100 through the one or more openings 132 of shell 122 which form the front face 126. A variety of insects, including mosquitoes, may be attracted to the trapping device 100 because of the lights 116, heater 110 and a mosquito attractant composition (not depicted) located in reservoir 176 of the insert 158. The lights can include one or more light emitting diodes (LEDs) and the heater 110 can include a single point heating element, such as a resistor. Further description of some non-limiting heaters and cartridges suitable for use with the mosquito attractant compositions disclosed herein are provided in PCT Patent App. No. PCT/US16/41811, entitled HEATED INSECT TRAPPING DEVICE AND METHODS THEREOF, and filed on Jul. 11, 2016, the disclosure of which is hereby incorporated by reference. The adhesive portion 152 and the mosquito attractant composition can be replaced by removal of the spent insert 158 (e.g., the adhesive portion is filled with insects and/or the attractant composition is exhausted) and its replacement with a new, fresh insert 158. The cartridge 118 can be placed over a shroud 108 comprising the heater 110. Other features depicted by the exemplary insect trapping device 100 of FIGS. 1 and 2 include electrical prongs 112 which provide power to the lights 116 and heater 110. Alternatively, the insect trapping device may be powered by a portable power supply, such as one or more batteries.

The mosquito attractant compositions can be utilized with an insect trapping device in multiple ways. For example, a packaged mosquito attractant composition can be removed from a package by a user by opening the package and removing the mosquito attractant composition disposed therein, which may include removing the composition itself, removing an insert having the mosquito attractant composition disposed therein or thereon, or removing a cartridge having the mosquito attractant composition disposed therein. The composition, insert or cartridge may then be utilized with an insect trapping device by exposing the mosquito attractant composition to air. The air may be within a space, such as a room of a residence of building. The mosquito attractant composition may be exposed to the air for a period of 7 days, 14 days or more, during which time the mosquito attractant composition attracts mosquitoes to the insect trapping device. In certain embodiments, the mosquito attractant composition, upon removal from the package, is placed in the reservoir of an appropriate insect trap device or insect trapping cartridge or the like, such as for example reservoir 176 defined in part by a front wall 180 as depicted in FIGS. 1 and 2.

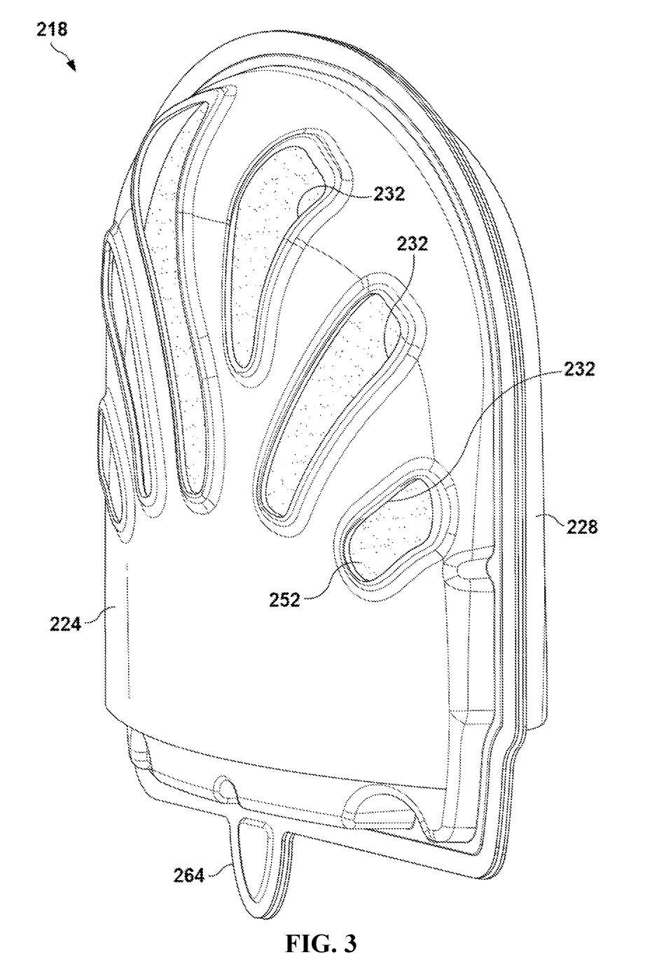

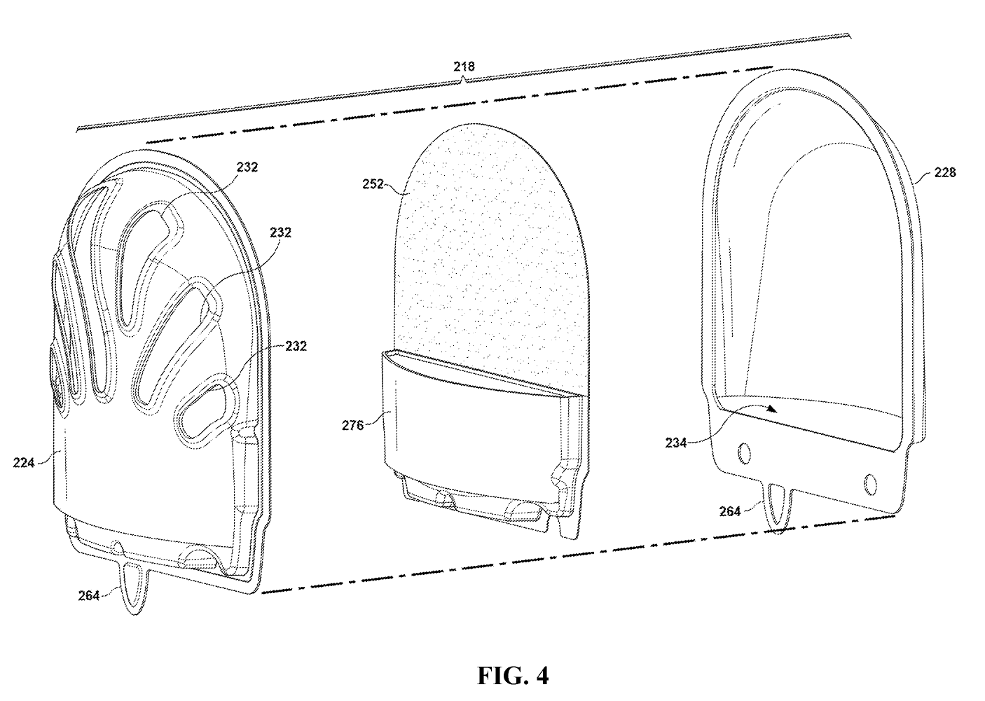

Alternatively, the mosquito attractant composition may be pre-disposed within the reservoir 276 of an insert 218, as depicted by way of example in FIGS. 3 and 4. Specifically, FIGS. 3 and 4 depicts a cartridge 218 for an insect trapping device which have adhesive portions 252 non-removably positioned inside the cartridge 218. In operation, the cartridge 218 may be affixed to the base of an insect trapping device, and then subsequent to use, the entire cartridge 218 may be removed and disposed of by the user. A fresh cartridge 218 may then be affixed to the base and operation of the insect trapping device can be resumed.

The cartridge 218 can include a reservoir 276 for a mosquito attractant composition, a front housing 224 and rear housing 228. The front housing 224 can include one or more openings 232 for receiving a flying or crawling insect such that they will come in contract with an adhesive portion 252. The rear housing can include a bottom opening 234. The front housing 224 and the rear housing 228 and, optionally, the adhesive portion 252, can be coupled using any suitable technique, such as ultrasonic welding, adhesives, mechanical fasteners, and the like. Alternatively, the front housing 224 and the rear housing 228 can be a unitary structure formed by, for example, injection molding. A downwardly depending tab 264 can be included to engage with an insect trapping device.

In some instances, alternative packages similar in some respects to the insert 218 can alternatively provide a mosquito attractant composition to an insect trapping device. For example, a package including only a reservoir containing the mosquito attractant composition may alternatively be provided. In other examples, a mosquito attractant composition may be provided without a structure similar to the insert 218. In such examples, an isolated mosquito attractant composition can be provided for direct placement in an insect trapping device.

Generally, a mosquito attractant composition can be formed and provided to an insect trapping device or insert in accordance to any method disclosed in Section VII. For example, an insect attractant cartridge including a mosquito attractant composition can be manufactured by forming a humectant premix from water and a humectant, introducing gellan gum into the humectant premix, heating the gel premix to a temperature of about 70° C. to about 80° C. and depositing the heated liquid attractant composition into an insect attractant cartridge and allowing the heated liquid attractant composition to cool to a temperature below about 65° C.

### X. TEST METHODS

pH Measurement of Mosquito Attractant Compositions

If it is desired to measure the pH of a gelled mosquito attractant composition, the following method may be used. The gelled mosquito attractant composition is removed from the cartridge or insert (in instances where it has been deposited therein). At least a 1 gm sample of the mosquito attractant composition is then, using a spatula or equivalent tool, mashed to a paste-like consistency and then added to distilled water and mixed while stirring (e.g., using a mechanical stirring device) to create a 10% solution of the sample in the distilled water (e.g., 9 gms of water would be added to a 1 gm sample). Following at least 5 minutes of stirring, the pH of the sample solution is measured using a pH meter (e.g., VWR SympHony model SP70P, or equivalent, using VWR probe cat. no. 89231-600, or equivalent) following calibration of the pH meter using several Buffer Reference Standard Solutions (e.g., available from VWR having a pH of 2, 4, and 7 or equivalent), as known in the art.

pH Measurement of Liquids

If it is desired to measure the pH of a liquid or a premix, the pH of the sample solution is measured using a pH meter (e.g., VWR SympHony model SP70P, or equivalent, using VWR probe cat. no. 89231-600, or equivalent) following calibration of the pH meter using several Buffer Reference Standard Solutions (e.g., available from VWR having a pH of 2, 4, and 7 or equivalent), as known in the art.

Mosquito Capture Test

Mosquito capture testing was conducted using an insect trapping device. The insect trapping device comprised a plug-in unit having disposed therein 2 blue LEDs and an ultraviolet LED. A replaceable cartridge comprising an adhesive for trapping the mosquitoes and the described mosquito attractant composition engaged the plug-in unit. A general description of the insect trapping device is provided in PCT Patent App. Publication No. WO 2015/081033 with respect to FIGS. 1 to 4 therein.

The test enclosure within which the insect trapping device was placed consisted of a mesh enclosure 6 feet by 6 feet by 6 feet in size. The enclosures were equipped with a 4 foot high by 3 foot wide section of vertical wallboard placed diagonally across 1 corner of the enclosure on a wooden base. The wallboard section contained a vertically mounted 12 V power strip such that the bottom of the power strip was 8 to 9 inches from the bottom of the wallboard. The test enclosures were placed in windowless rooms and the bottom perimeter was sealed with duct tape. The rooms were continuously measured to have an average temperature of 24° C. and an average relative humidity of 47%. Four vertical floor lamps were placed around the outside of the enclosure to provide lighting with each lamp having a single 800-900 lumen CFL bulb which was kept on for the duration of the test.

Mosquitoes were reared according to protocols known in the art. Specifically, adult Aedes aegypti mosquitoes were held at 27° C. under long day lengths with free access to 10% sucrose and water ad libitum. Females (two weeks after adult emergence) were allowed access to a bloodmeal with a Hemotek blood feeding system. Females were collected two to three days after blood feeding and moved into a small plastic container half filled with water and a small pinch of ground fish food. Eggs were dried for one week before being placing in the small container. After one day, 100-120 larvae were counted and placed into a large plastic container half filled with water. Each day excess ground fish food was added to ensure that the larvae had food for development. Pupae were collected in small emergence cups and placed within 12″ by 12″ by 12″ cages (Bioquip 1450BS). Adults were utilized 12 to 20 days post ecdysis.

After the start of the test, 50 female mosquitoes were released into the tent. At the end of each measured capture period, the percentage of mosquitoes captured by the device was determined by counting them and dividing by the total released. Each test was run at least five times and the results were averaged.

Open Container Stability Test

As used herein, the Open Container Stability Test indicates whether a gel composition sample remains stable when exposed to air. In the Open Container Stability Test, a 25 g±1 g liquid gel composition (prior to forming a gel network) is dispensed into a 2 oz flint glass jar (Qorpak GLA-00843) and allowed to cool and solidify at ambient conditions of 22° C. to 26° C. and 40%-80% relative humidity with the jar open and in an upright, un-tilted orientation (typically at least 60 minutes). The solidified gel and jar are then placed in a constant humidity and constant temperature room maintained at a constant temperature of about 40° C. and about 20% relative humidity. The jar is in the open condition in the test room, and the open jar is oriented at approximately a 45 degree angle within the test room for 30 days. The gel sample integrity is determined at the end of 14 days and/or 30 days by qualitatively assessing the gel sample according to the following criteria:

1. No flowing of the gel sample within the jar.

2. The gel sample has flowed within the jar.

A gel composition is considered to pass the Open Container Stability Test when criteria #1 is satisfied. Shrinkage of the gel sample due to loss of water from the sample is not considered a flow condition satisfying criteria #2.

Closed Container Syneresis Test

As used herein, the Closed Container Syneresis Test indicates whether a gel sample exhibits syneresis when sealed within a closed container. In the Closed Container Syneresis Test, a 25 g±1 g liquid gel composition (prior to forming a gel network) is dispensed into a 2 oz flint glass jar (Qorpak GLA-00843) and allowed to cool and solidify at ambient conditions of 22° C. to 26° C. and 40%-80% relative humidity for 90 minutes with the jar open and in an upright, un-tilted orientation. Once a gel has formed, any existing condensation on the sides of the open jar is removed with an absorbent laboratory wipe and the jar is then closed tightly by a lid. The closed jar with the gel is then placed in a constant humidity and constant temperature room maintained at a constant temperature of about 40° C. and about 20% relative humidity. The closed jar is oriented at approximately a 90 degree angle. The presence of syneresis is determined 24 to 72 hours from placement in the test room. If water is visible within the closed jar, then the jar is opened and an absorbent laboratory wipe is used to remove the water and the amount of water absorbed by the wipe is determined by weighing the wipe and calculating the difference in the weight of the wipe prior to absorption of the water and after. The following criteria are used to qualitatively assess whether the gel sample has undergone syneresis:

1. No condensation visible in jar or slight condensation visible in jar but not enough to form a drop in the tilted orientation (i.e., less than 100 μL of water).

2. More than 100 μL of water has pooled within the jar.

A gel composition is considered to pass the Closed Container Syneresis Test if criteria #1 is satisfied. A gel composition is considered to have failed this test if criteria #2 is satisfied.

### XI. EXAMPLES

The following examples are given solely for the purpose of illustration and are not to be construed as limitations of the invention as many variations are possible without departing from the spirit and the scope of the invention. The target pH values provided in the Tables for the following Examples represent the target pH value for the mosquito attractant composition. As provided below, certain combinations of ingredients were adjusted to the desired target pH value by the addition of a pH adjusting agent (except in the case of situation #3, where no pH adjusting agent was added).
1. For Examples without lactic acid where the target pH of the mosquito attractant composition is 2.5, the pH of the distilled water and humectant combination was adjusted using hydrochloric acid to achieve the target pH with respect to this combination.
2. For Examples without lactic acid where the target pH of the mosquito attractant composition is 5.6 or 7.5, the pH of the distilled water and glycerol combination was adjusted using sodium hydroxide to achieve the target pH with respect to this combination.
3. For Examples without lactic acid where the target pH of the mosquito attractant composition is 4.6, no pH adjusting was added to any combination of ingredients since the pH of the distilled water and glycerol was measured to be about 4.6.
4. For Examples comprising lactic acid where the target pH of the mosquito attractant composition is 2.5, 4 or 4.5, the pH of the humectant, distilled water, lactic acid combination was adjusted by the addition of sodium hydroxide to achieve the target pH of this combination.

While the pH of the mosquito attractant compositions were not measured directly for the following Examples, it is believed the pH of the certain ingredient combinations adjusted using pH adjusting agents as provided above should result in about the target pH of the mosquito attractant composition, recognizing that it's possible that the actual pH of the mosquito attractant composition in situations #2 and #3 may vary slightly from the target pH due to the addition of the gelling agent. Unless noted otherwise, the gellan gum for each example is KELCOGEL® AFT, a low-acyl, low-purity, gellan gum and water is distilled water.

Mosquito capture percentages are measured in accordance with the Mosquito Capture Test of Section X, wherein the sample size of insect trapping device was N=3 for each test and measurements were taken after 24 hours or 14 days as indicated. Capture data for all three samples of each leg are presented in the Tables. Mosquito capture results at 24 hours are conducted by using a freshly prepared mosquito attractant composition deposited in an insect cartridge and placed into a plastic bag for transportation to a separate laboratory, where the bag was opened and the test was run.

In instances where 14 day mosquito capture data is provided, the test was conducted as follows. The mosquito attractant composition was deposited in an insect cartridge and was thereafter exposed to ambient air under laboratory conditions for 14 days, as applicable. Laboratory conditions were approximately 21° C. to 27° C. temperature and 50% to 60% relative humidity. After 14 days of exposure to ambient air under laboratory conditions, the cartridge was placed in a plastic bag for preservation and transported to a separate laboratory where the cartridge was unsealed and the Mosquito Capture Test Method was conducted for a period of 24 hours to determine the mosquito capture following the 14 days of prior exposure to ambient air.

### Examples 1 to 5

Examples 1 to 3 (set forth in Table 1) are mosquito attractant compositions formed with different humectants (e.g., glycerol, sorbitol and propylene glycol). Example 1 included 6.25%, by weight, glycerol. Example 2 included 6.25%, by weight, sorbitol. Example 3 included 6.25%, by weight, propylene glycol. Each of examples 1 to 3 further comprised approximately 91% distilled water, by weight, of the mosquito attractant composition. Example 4 is a comparative example that comprised 2.5 grams of water on a 37 mm×10 mm cylindrical piece of dental cotton disposed in the insect trapping device. Formulations, target pHs of the mosquito attractant composition, and mosquito capture rates for each sample are set forth in Table 1 (NA=Not Applicable). Example 5 is a comparative example illustrating mosquito capture after 24 hrs for an insect trapping device without a mosquito attractant composition (but still comprising lights and an adhesive sheet). Since it is believed that mosquito capture for example 5 should be the same after 14 days as after 24 hrs, only the mosquito capture after 24 hours is presented. The 24 hour capture data set forth in Table 1 for this example is for N=99 devices and the values for the high/low/average/and 1 std deviation of mosquito capture after 24 hours are presented.

TABLE 1

| | Gellan | | | Propylene | | | |
|---|---|---|---|---|---|---|---|
| | Gum | Glycerol | Sorbitol | Glycol | | 24 Hour | 14 Day |
| | (weight | (weight | (weight | (weight | Target | Catch | Catch |
| Example | percent) | percent) | percent) | percent) | pH | Percentage | Percentage |
| 1 | 1% | 6.25% | NA | NA | 2.5 | 72% | 70% |
| | | | | | | 80% | 68% |
| | | | | | | 84% | 40% |
| 2 | 1% | NA | 6.25% | NA | 2.5 | 70% | 10% |
| | | | | | | 80% | 38% |
| | | | | | | 62% | 48% |
| 3 | 1% | NA | NA | 6.25% | 2.5 | 62% | 42% |
| | | | | | | 70% | 80% |
| | | | | | | 58% | 56% |
| 4 | NA | NA | NA | NA | NA | 37% | NA |
| 5 | NA | NA | NA | NA | NA | High: 54% | NA |
| | | | | | | Low: 0% | |
| | | | | | | Avg: 22% | |
| | | | | | | 1 Std Dev: ±13% | |

Examples 1 to 3 each demonstrated substantially higher mosquito capture rates than comparative Example 4 after 24 hours despite none of Examples 1-3 including a classical mosquito attractant active. Compositions comprising glycerol or propylene glycol appeared directionally better than sorbitol at the same weight concentrations for mosquito capture at 14 days, indicating that perhaps more water vapor was emitting from the polyol samples. Examples 1-3 were all better at 24 hours and presumably 14 days than Example 5 and may indicate effective sustained release of water vapor at day 14.

### Example 6

Example 6 (set forth in Table 2) illustrates the effect caused by increasing the quantity of humectant included in a mosquito attractant composition. The mosquito attractant composition of Example 6 comprised 50%, by weight, glycerol; and approximately 49%, by weight, of distilled water. Example 6 illustrates that increasing the amount of glycerol to 50%, by weight, directionally reduced the mosquito capture rate at 14 days compared to Example 1. It is believed that, in certain embodiments, humectant concentrations less than 50%, by weight, may be beneficial if it is desired to maximize mosquito capture at 14 days in the absence of a second mosquito attractant, such as lactic acid.

TABLE 2

| | Gellan Gum | Glycerol | | 24 Hour | 14 Day |
|---|---|---|---|---|---|
| | (weight | (weight | Target | Catch | Catch |
| Example | percent) | percent) | pH | Percentage | Percentage |
| 6 | 1% | 50% | 2.5 | 64% | 22% |
| | | | | 30% | 32% |
| | | | | 54% | 36% |

### Examples 7 to 12

Examples 7 to 12 (set forth in Table 3) are mosquito attractant compositions formed at different pH values ranging from 2.5 to 12. Given the variability of accurately achieving the target pH of near pH neutral mosquito attractant compositions through pH adjustment of the water prior to gellan addition, it is believed the 14 day mosquito capture results for pHs from 4.6 to 7.5 represent a general trend across this pH range versus being representative of the results for the particular target pH. The mosquito attractant compositions of Examples 7 to 12 comprised glycerol at 6.25%, by weight; distilled water at approximately 92% by weight; and gellan gum at 1%, by weight.

TABLE 3

| | Gellan Gum | Glycerol | | 24 Hour | 14 Day |
|---|---|---|---|---|---|
| | (weight | (weight | Target | Catch | Catch |
| Example | percent) | percent) | pH | Percentage | Percentage |
| 7 | 1% | 6.25% | 12 | 54% | 40% |
| | | | | 60% | 28% |
| | | | | 68% | 28% |
| 8 | 1% | 6.25% | 10.6 | 34% | 36% |
| | | | | 78% | 54% |
| | | | | 74% | 26% |
| 9 | 1% | 6.25% | 7.5 | 18% | 22% |
| | | | | 98% | 12% |
| | | | | 38% | 20% |
| 10 | 1% | 6.25% | 5.6 | 80% | 22% |
| | | | | 66% | 16% |
| | | | | 48% | 42% |
| 11 | 1% | 6.25% | 4.6 | 66% | 22% |
| | | | | 86% | 10% |
| | | | | 50% | 18% |
| 12 | 1% | 6.25% | 2.5 | 72% | 70% |
| | | | | 80% | 68% |
| | | | | 84% | 40% |

The results of Table 3 surprisingly indicate that the mosquito attractant compositions having a pH less than about 4, more preferably less than 3, have improved mosquito capture at 14 days compared to mosquito attractant compositions have a pH from 4.5 to 7.5. Still further, Examples 7 and 8 seem to indicate that the mosquito attractant compositions having a pH from about 10 to about 12 have directionally better mosquito capture than mosquito attractant compositions having a pH from 4.5 to 7.5.

### Examples 13 to 16

Examples 13 to 16 (set forth in Table 4) are mosquito attractant compositions comprising different grades of gellan gum. Example 13 comprised KELCOGEL® AFT Low Purity (a low acyl gellan gum available from CP Kelco, USA), Example 14 comprised KELCOGEL® High Purity (a low acyl gellan gum available from CP Kelco, USA), Example 15 comprised KELCOGEL® F High Purity (a low acyl, food grade, gellan gum available from CP Kelco, USA) and Example 16 comprised KELCOGEL® LT100 (a high acyl gellan gum available from CP Kelco, USA). The mosquito attractant compositions of Examples 13 to 16 further comprised glycerol at 6.25%, by weight; distilled water at approximately 92%, by weight; and gellan gum at 1%.

TABLE 4

| | Gellan Gum | Glycerol | | 24 Hour | 14 Day |
|---|---|---|---|---|---|
| | (weight | (weight | Target | Catch | Catch |
| Example | percent) | percent) | pH | Percentage | Percentage |
| 13 | 1% | 6.25% | 4.6 | 66% | 22% |
| | | | | 86% | 10% |
| | | | | 50% | 8% |
| 14 | 1% | 6.25% | 4.6 | NA | 20% |
| | | | | | 26% |
| | | | | | 12% |
| 15 | 1% | 6.25% | 4.6 | 81% | 24% |
| | | | | 60% | 28% |
| | | | | 81% | 66% |
| 16 | 1% | 6.25% | 4.6 | NA | 36% |
| | | | | | 44% |
| | | | | | 44% |

Compared to Example 1 (pH 2.5), each of Examples 14 to 16 (pH 4.6) appear directionally worse for mosquito capture at 14 days, although Example 16 (high acyl) appears directionally better than Examples 13 to 15 (low acyl) for mosquito capture at 14 days. In certain embodiments, high acyl gellan gums may be better for mosquito capture at pHs greater than about 4 while the low acyl gellan gums may be better at lower pHs (e.g., between about 2.5 and about 3.5).

### Examples 17 to 21

Examples 17 to 21 (set forth in Table 5) are mosquito attractant compositions comprising either agar or gellan gum comparing the stability of the mosquito attractant composition at pHs between 2.5 and 4. While these Examples all include lactic acid, it is believed that the results will be similar for other mosquito attractant compositions without lactic acid but having a target pH of 2.5 (presumably achieved by the addition of an acidic pH adjusting agent) since the stability is believed to be primarily driven by hydrolysis. Example 21 comprised KELCOGEL® AFT Low Purity (a low acyl gellan gum available from CP Kelco, USA) and Examples 17 to 20 comprised agar. The mosquito attractant compositions of Examples 17 to 21 further comprised glycerol at 6.25%, by weight; and distilled water at approximately 70%, by weight. Examples 17, 18 and 198 (agar, target pH of 2.5, 3.0, 3.5) failed the Open Container Test at 30 days but passed this test when checked at 14 days. Example 20 (agar, target pH of 4.0) passed the Open Container test at both 14 days and 30 days, as did Example 21 (agar plus gellan gum and having a target pH of 2.5). These Examples illustrate that gellan gum may be preferred for a target pH of less than 4 while both agar and gellan gum may be suitable for use for a pH greater than 4. The agar Examples 17 to 21 also illustrate that in situations where stability for less than 14 days is desired, an agar mosquito attractant composition may be suitable.

TABLE 5

| | Exam- | Exam- | Exam- | Exam- | Exam- |
|---|---|---|---|---|---|
| | ple 17 | ple 18 | ple 19 | ple 20 | ple 21 |
| Agar | 4% | 4% | 4% | 4% | 4% |
| Gellan Gum | NA | NA | NA | NA | 1% |
| (KELCOGEL ® AFT) | | | | | |
| Lactic Acid | 17.38% | 17.38% | 17.38% | 17.38% | 17.38% |
| Glycerol | 6.25% | 6.25% | 6.25% | 6.25% | 6.25% |
| Target pH | 2.5 | 3 | 3.5 | 4 | 2.5 |
| Distilled Water | q.s. | q.s | q.s | q.s. | q.s. |
| Total | 100% | 100% | 100% | 100% | 100% |
| Open Container | PASS | PASS | PASS | PASS | PASS |
| Test (14 Days) | | | | | |
| Open Container | FAIL | FAIL | FAIL | PASS | PASS |
| Test (30 Days) | | | | | |
| Closed Container | PASS | PASS | PASS | PASS | PASS |
| Test | | | | | |

The following numbered paragraphs constitute a further non-limiting description of the disclosure in a form suitable for appending to the claim section if later desired.

A.1. A method of using a mosquito attractant composition, comprising:

exposing the mosquito attractant composition to air for a period of at least 7 days, wherein the mosquito attractant composition comprises:
from about 0.5% to about 5% of a gellan gum;
from about 0.5% to about 50% of a humectant; and from about 45% to about 95% water; and

wherein the mosquito attractant composition attracts mosquitoes when exposed to the air.

A.2. The method according to claim A.1, wherein the mosquitoes are attracted to the mosquito composition for at least 7 days.
A.3. The method according to any of the preceding claims, wherein the mosquito attractant composition is exposed to air for at least 14 days and wherein the mosquitoes are attracted to the mosquito attractant composition for at least 14 days.
A.4. The method according to any of the preceding claims, wherein the mosquito attractant composition comprises, by weight:
from about 0.5% to about 2% of the gellan gum;
from about 5% to about 30% of the humectant; and
from about 70% to about 95% water.
   A.5. The method according to any of the preceding claims, wherein the humectant comprises one or more of glycerol, sorbitol, xylitol, ethylene glycol, diethylene glycol, polyethylene glycol, and propanediol.
   A.6. The method according to any of the preceding claims, wherein the humectant comprises glycerol.
   A.7. The method according to any of the preceding claims, wherein the mosquito attractant composition has a pH from about 2 to about 4.
   A.8. The method according to any of the preceding claims, wherein the gellan gum comprises a low acyl gellan gum.
   A.9. The method according claim A.9, wherein the gellan gum consists essentially of a low acyl gellan gum.
   A.10. The packaged mosquito attractant according to any of claims A.1. to A.6, wherein the mosquito attractant composition has a pH of about 9 to about 12.
   A.11. The method according to any of claims A.1 to A.7, wherein the gellan gum comprises a high acyl gellan gum.
   A.12. The method according to claim A.11, wherein the gellan gum consists essentially of a high acyl gellan gum.
   A.13. The method according to any of the preceding claims, wherein the mosquito attractant composition further comprises a pH adjusting agent.
   A.14. The method according to any of the preceding claims, wherein the mosquito attractant composition has a bulk mass of about 10 grams to about 30 grams.
   A.15. The method according to any of the preceding claims, wherein the mosquito attractant composition consists essentially of:

from 0.5% to 1.5% of the gellan gum;

from 5% to 15% of the humectant;

from 50% to 99% water; and

optionally, a pH adjusting agent.

A.16. The method according to any of the preceding claims, wherein the mosquito attractant composition is disposed within a package and the method further comprises opening the package, removing the mosquito attractant composition from the package before exposing the mosquito attractant composition to the air.
A.17. The method according to any of the preceding claims, wherein the mosquito attractant composition is exposed to air in a room of a building.
A.18. The method according to any of the preceding claims, wherein the mosquito attractant composition is used with an insect trapping device that is powered by electricity.
A.19. The method according to any of the preceding claims, wherein the mosquito attractant composition is homogeneous.
B.1. An insect trapping portion for use with an insect trapping device, the insert trapping portion comprising:

an adhesive for trapping an insect;

a mosquito attractant composition comprising, by weight:
from about 0.5% to about 5% gellan gum;
from about 0.5% to about 50% of a humectant; and
from about 45% to about 95% water.
   B.2. The insect trapping portion of claim B.1, wherein the mosquito attractant composition is disposed adjacent to or is contacting the adhesive.
   B.3. The insect trapping portion according to claims B.1 or B.2, further comprising a reservoir and the mosquito attractant composition is at least partially disposed within the reservoir.
   B.4. The insect trapping portion according to claims B.1 to B.3, further comprising at least one housing, wherein the mosquito attractant composition is disposed within the housing.
   B.5. An insect trapping device, comprising an insect trapping portion according to claims B.1 to B.4 and a base unit comprising at least one light for illuminating the adhesive of the insect trapping portion.
   B.6. An insect trapping device according to claim B.5, wherein the insect trapping device does not comprise a means for producing carbon dioxide.
   B.7. An insect trapping device according to claims B.1 to B.6, wherein the humectant comprises one or more of glycerol, sorbitol, xylitol, ethylene glycol, diethylene glycol, polyethylene glycol, and propanediol.
   B.8. An insect trapping device according to claims B.1 to B.7, wherein the humectant comprises glycerol.
   B.9. An insect trapping device according to claims B.1 to B.8, wherein the mosquito attractant composition has a pH from about 2 to about 4.
   B.10. An insect trapping device according to claims B.1 to B.9, wherein the gellan gum comprises a low acyl gellan gum.
   B.11. An insect trapping device according to claim B.10, wherein the gellan gum consists essentially of a low acyl gellan gum.
   B.12. An insect trapping device according to claims B.1 to B.9, wherein the gellan gum comprises a high acyl gellan gum.
   B.13. An insect trapping device according to claim B.12, wherein the gellan gum consists essentially of a high acyl gellan gum.
   B.14. An insect trapping device according to claims B.1 to B.13, wherein the mosquito attractant composition further comprises a pH adjusting agent.
   B.15. An insect trapping device according to claims B.1 to B.14, wherein the mosquito attractant composition has a pH of about 9 to about 12.
   B.16. An insect trapping device according to claims B.1 to B.14, wherein the mosquito attractant composition has a pH from about 2 to about 4.
   B.17. An insect trapping device according to claims B.1 to B.16, wherein the mosquito attractant composition is used with an insect trapping device that is powered by electricity.
   B18. An insect trapping device according to claim B.1 to B.17, wherein the mosquito attractant composition is homogeneous.
   C.1. A method of making an insect attractant cartridge, comprising:

forming a humectant premix by mixing water and a humectant;

introducing gellan gum into the humectant premix to form a gel premix;

heating the gel premix to a temperature of about 70° C. to about 80° C. to form a heated liquid attractant composition;

depositing the heated liquid attractant composition into the insect attractant cartridge; and

cooling the heated liquid attractant composition to a temperature below about 65° C.

C.2. The method according to claim C.1, wherein the gel premix is mixed with a high shear mixer.
C.3. The method according to claim C.1 or claim C.2, wherein the heated liquid attractant composition is heated for about 1 minute or longer.
C.4. The method according to any of claims C.1 to C.3, wherein the heated liquid attractant is cooled without shear.
C.5. The method according to any of claims C.1 to C.4, wherein the humectant comprises one or more of glycerol, sorbitol, xylitol, ethylene glycol, diethylene glycol, polyethylene glycol, and propanediol.
C.6. The method according to claim C.5, wherein the mosquito attractant composition comprises about 0.5% to about 45%, by weight, of the humectant.
C.7. The method according to any of claims C.1 to C.6, wherein the mosquito attractant composition comprises about 0.5% to about 5%, by weight, of the gellan gum.
C.8. The method according to any of claims C.1 to C.7, wherein the mosquito attractant composition comprises about 1% to about 1.5%, by weight, of the gellan gum.

The dimensions and/or values disclosed herein are not to be understood as being strictly limited to the exact numerical dimension and/or values recited. Instead, unless otherwise specified, each such dimension and/or value is intended to mean both the recited dimension and/or value and a functionally equivalent range surrounding that dimension and/or value. For example, a dimension disclosed as “40 mm” is intended to mean “about 40 mm”.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

All percentages and ratios used herein are by weight of the total mosquito attractant composition and all measurements made are at 25° C., unless otherwise designated. All measurements used herein are in metric units unless otherwise specified.

What is claimed is:

1. A method of using a mosquito attractant composition, comprising:
exposing the mosquito attractant composition to air for a period of at least 7 days, wherein the mosquito attractant composition comprises:
from about 0.5% to about 5% of a gellan gum;
from about 0.5% to about 50% of a humectant; and
from about 45% to about 95% water; and
wherein the mosquito attractant composition attracts mosquitoes when exposed to the air.

2. The method according to claim 1, wherein the mosquitoes are attracted to the mosquito composition for at least 7 days.

3. The method according claim 1, wherein the mosquito attractant composition is exposed to air for at least 14 days and wherein the mosquitoes are attracted to the mosquito attractant composition for at least 14 days.

4. The method according to claim 1, wherein the mosquito attractant composition comprises, by weight:
from about 0.5% to about 2% of the gellan gum;
from about 5% to about 30% of the humectant; and
from about 70% to about 95% water.

5. The method according to claim 1, wherein the humectant comprises one or more of glycerol, sorbitol, xylitol, ethylene glycol, diethylene glycol, polyethylene glycol, and propanediol.

6. The method according to claim 1, wherein the humectant comprises glycerol.

7. The method according to claim 1, wherein the mosquito attractant composition has a pH from about 2 to about 4.

8. The method according to claim 1, wherein the gellan gum comprises a low acyl gellan gum.

9. The method according claim 8, wherein the gellan gum consists essentially of a low acyl gellan gum.

10. The packaged mosquito attractant according to claim 1, wherein the mosquito attractant composition has a pH of about 9 to about 12.

11. The method according to claim 1, wherein the gellan gum comprises a high acyl gellan gum.

12. The method according to claim 11, wherein the gellan gum consists essentially of a high acyl gellan gum.

13. The method according to claim 1, wherein the mosquito attractant composition has a bulk mass of about 10 grams to about 30 grams.

14. The method according to claim 1, wherein the mosquito attractant composition consists essentially of:
from 0.5% to 1.5% of the gellan gum;
from 5% to 15% of the humectant;
from 50% to 99% water; and
optionally, a pH adjusting agent.

15. The method according to claim 1, wherein the mosquito attractant composition is disposed within a package and the method further comprises opening the package, removing the mosquito attractant composition from the package before exposing the mosquito attractant composition to the air.

16. The method according to claim 1, wherein the mosquito attractant composition is exposed to air in a room of a building.

17. The method according to claim 1, wherein the mosquito attractant composition is used with an insect trapping device that is powered by electricity.

18. The method according to claim 1, wherein the mosquito attractant composition passes one or more of the Closed Container Syneresis Test and the Open Container Stability Test at 30 days.
